(19) United States
(12) Patent Application Publication
(10) Pub. No.: US 2003/0133284 A1
(43) Pub. Date: Jul. 17, 2003

(54) Reflectors

(76) Inventors: Jan Chipchase, Tokyo (JP); Johan Bergquist, Tokyo (JP); Max Lindfors, Helsingfors (FI)

Correspondence Address: Scheef & Stone, L.L.P., Suite 1400, 5956 Sherry Lane, Dallas, TX, 75225, US

(21) Appl. No.: 10/319,418

(22) Filed: Dec. 13, 2002

(30) Foreign Application Priority Data
Dec. 21, 2001 (GB) 0130688.5

(51) Int. Cl. F21V 7/04

(52) U.S. Cl. 362/31

(57) ABSTRACT

A display device comprising: display element switchable to adjust the transmission of light therethrough; and a reflector located behind the display element for receiving ambient light transmitted through the display element and reflecting it back through the display element; wherein the diffusivity of the reflector is adjustable.

### CROSS-REFERENCE TO RELATED APPLICATION

The present invention claims the priority of United Kingdom application 0130688.5, filed on Dec. 21, 2001.

This invention relates to reflectors, for example cosmetic mirrors and back reflectors for display devices such as liquid crystal displays (LCDs). Such reflectors could, for example, be suitable for use in devices such as mobile phones.

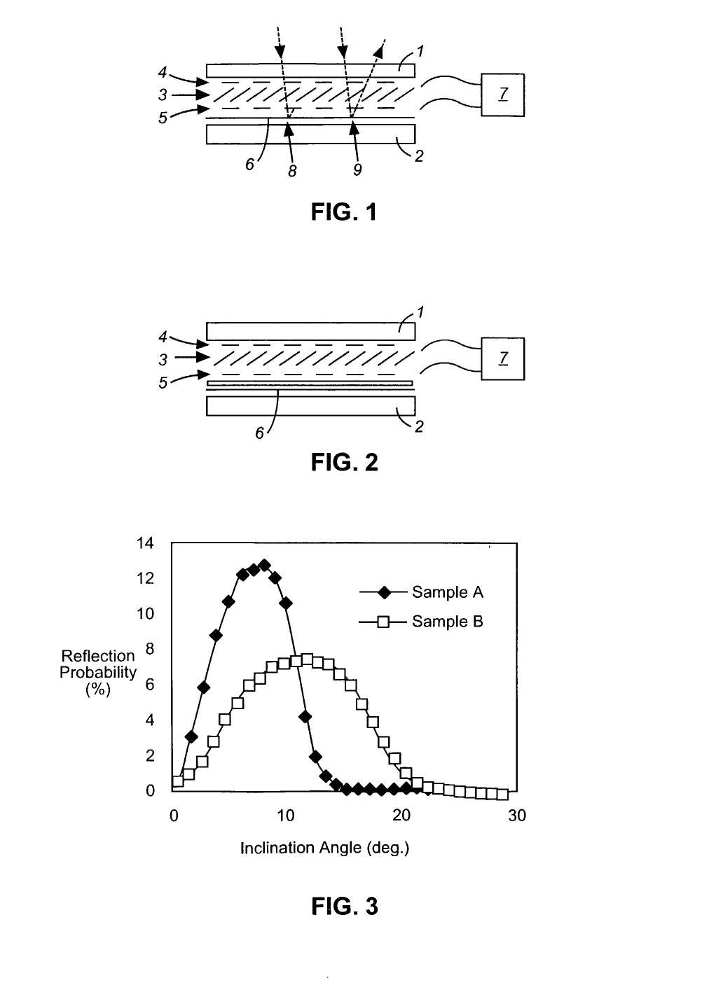

FIG. 1 illustrates the operation of a typical reflective or transflective LCD unit. The display comprises a pair of glass sheets 1, 2 between which is located a layer of liquid crystal 3. Electrodes 4, 5 are formed on the surfaces of the glass sheets adjacent the liquid crystal. The electrodes are patterned in the form that individual pixels of the display are desired to take. A mirror 6 is located behind the liquid crystal with respect to the viewing direction. The liquid crystal, the electrodes and their drive circuitry 7 are arranged so that when no voltage is applied across the electrodes of a pixel, ambient light that enters the device and is reflected by the mirror 6 is blocked by a polariser (which for clarity is not shown in the drawings) so that it does not re-emerge. (See pixel 8). On the other hand, when a voltage is applied across the electrodes of a pixel, ambient light that enters the device and is reflected by the mirror 6 passes through the liquid crystal layer and emerges from the device. (See pixel 9). As a result, a viewer sees pixels where no voltage is applied as being dark and pixels where a voltage is applied as bright.

The quality of image produced by the display is dependant on the degree of contrast between activated and non-activated pixels. It has been found that this is dependent on the way in which the display is illuminated. If the display is illuminated by a point light source such as a desk lamp the display should exhibit a greater degree of Lambertian (diffuse) reflection in order to avoid annoying glare and specular reflection (mirrorishness). In contrast, if the display is illuminated by a diffuse light source such as a cloudy sky or indirect office lighting the display should preferably have a greater degree of specular (mirrorish) reflection in order to give a brighter image. A greater degree of diffusion leads to less directed light and therefore lower brightness.

In designing displays, designers normally select the mirror 6 to have the properties that they feel provide the best compromise for the types of illumination to which the device is expected to be subject. To achieve this the reflective layer(s) themselves may be adapted, or a static diffuser may be overlain on the mirror. However, this means that for much of the time the performance of the display is far from optimal. Further details of this process are given in “Designing of Ideal Diffusing Reflector with High Reflectance in Actual Environments”, N Sugiura et al., Asia Display/IDW '01, 621-624.

With a display that is too mirrorish, the user is forced to tilt the display to reduce reflections of point light sources, resulting in lower image brightness. In anti-glare systems (intentional diffusion on the front surface to reduce glare), another approach has been to use a so-called beam steering film attached on the front face. It holographically reflects light incident on the top glass so that the outgoing angle is different from the angle of the light reflected by the display mirror. Although this reduces glare, it does not reduce the specular component of the point light source that is reflected by the display mirror. As a result, an image of the point light source will be superimposed on the display image. Furthermore, holographic diffusers generally have chromatic angular dependence which colourises the image at certain viewing angles.

An alternative approach uses beam steering technology, which has been presented by DuPont, Polaroid and 3M at the Society for Information Display annual symposiums in 1999 and 2000.

With display that is too diffusing, the brightness is unsatisfactorily low. This problem has been solved by the user moving to a brighter location or adding auxiliary lighting systems either behind or in front of the display.

In Japanese patent H11-202301non-adjustable layers of polymer dispersed liquid crystal (PDLC) have been proposed in order to solve the problem of parallax while keeping production costs low.

Reflective electronic displays exist. They have either a diffusing mirror in the back plane or a diffusing film peeled onto the front face. While the latter approach is simple and inexpensive, the distance between the back-plane mirror and diffuser introduces parallax which makes the image fuzzy and prohibits high-resolution imaging. Diffusing mirrors inside the LCD cell, i.e., cell electrodes also functioning as a reflector, completely eliminate such parallax but are expensive to manufacture and also tend to show an annoying achromaticity (usually yellowish or greenish).

There is therefore a need for an improved form of display whose embodiments can at least partially address one or more of the above problems. The inventors of the present invention have noted that this can be achieved by means of a reflector that has other uses too.

According to one aspect of the present invention there is provided a reflector as set out in the independent claims.

Preferred features of the invention are set out in the dependent claims.

In the accompanying drawings:

FIG. 1 is a schematic cross-section of a liquid crystal display;

FIG. 2 is a schematic cross-section of another liquid crystal display; and

FIG. 3 is a plot of reflection probability against inclination angle for a pair of reflectors A and B.

The present invention will now be described by way of example with reference to the drawings.

FIG. 2 shows a display device in which like parts are numbered as for FIG. 1. The display of FIG. 2 includes an adjustable diffuser 8 set in front of the mirror 6. The adjustable diffuser can be adjusted by means of an electrical control signal supplied by diffuser controller 9. The extent to which the diffuser diffuses light passing through it depends on the control signal. The diffuser controller can base the control signal on an input from a user-operable selector 10 and/or from a light sensor 11 which senses ambient light. Other means of control could be chosen.

The device of FIG. 2 has one or more polarisers which, for clarity, have are not shown in FIG. 2. These are implemented as in conventional LCD displays.

The display of FIG. 2 has an adjustable diffuser 8 which takes the place of the fixed diffuser 8 (if any) of the prior art. The adjustable diffuser could be implemented in a number of ways. For instance, it could be a switchable PDLC (polymer-dispersed liquid crystal) layer, both surfaces of which are covered by an electrode material and connected to the control circuitry 9. In the PDLC layer droplets of liquid crystals with anisotropic refractive indices are dispersed in a polymer with the same refractive index as the longitudinal refractive index of the liquid crystals. By applying an electric field across the polymer, the molecules are reoriented in a way such that the indices of refraction of the liquid crystals and the surrounding polymer match. An optical film with a spatially uniform index of refraction does not scatter light and thus gives a transparent appearance. If the electric field is turned off, the liquid crystals will orient themselves randomly and there will be a mismatch between the indices of refraction, thus introducing scattering. Intermediate degrees of reorientation yield intermediate levels of diffusion. The PDLC film is applied either on top of the back plane mirror or on the display's front surface and provides achromatic, continuous switching between the transparent and diffusive states.

The diffuser could be implemented in a MEMS (micro electro-mechanical system) display unit such as those available from Iridigm Display Corporation.

To integrate the adjustable PDLC diffuser with a display, the diffusing mirrors of conventional displays could be replaced with a specular mirror on which an adjustable PDLC diffuser is attached. For non-LCD displays such as direct-view MEMS displays by Iridigm Corporation, the PDLC diffusing layer can be applied before depositing the mirror films. In another implementation a PDLC film could simply be attached on top of an existing display. However, this would give some parallax.

Where applicable, the electrode-coated PDLC stack or other adjustable diffuser could be sandwiched between the back mirror 6 and the lower face of the bottom glass substrate 2 or between the electrode 5 and the liquid crystal cell. In the latter case, the LCD electrode and at least one electrode of the PDLC could be shared.

The electrode 5 is suitably an intra-cellular specularly reflecting electrode. An intra-cellular mirror gives reduced parallax, whereas rear face mirrors are generally easier to manufacture.

The adjustable diffuser is controlled so as to set the contrast of the display. Whereas point light sources call for more diffusion to avoid annoying glare and specular reflections (mirrorishness), diffuse light sources such as a cloudy sky or indirect office illumination give a brighter image if the reflecting layer of a display has more specular (mirrorish) reflection. More diffusion leads to less directed light and therefore lower brightness. By minimising diffusion without introducing annoying glare or specular reflections, the brightness can be enhanced under a range of illumination conditions.

One way for the diffuser to be set in the desired way is for it to be adjusted under user control by means of selector 10 which provides an input to control circuit 9. The user could select between a number of display options, for example corresponding to one or more of six kinds of ambient light sources applicable to reflective displays: (1) sunny sky, (2) cloudy sky, (3) direct office light (fluorescent tubes), (4) indirect (diffuse) office light, (5) direct home light (fluorescent light bulbs, incandescent light bulbs, halogen lamps, etc), and (6) diffuse, indirect home light. By “indirect light” is meant light that is reflected against some surface, which changes the spectral distribution of the original light source. Another way to select the contrast setting is for the current ambient light conditions to be sensed by a light sensor 11 which provides an input to controller 9. By comparing selective parts of the incoming light spectra at the sensor 11 with known discrete and/or continuous spectra (e.g. the spectra associated with the light sources 1-6 listed above), it is possible to determine the kind of ambient light and its degree of diffusiveness. One way to measure the amount of diffuse light is to use a linear sensor array onto which a lens focuses the ambient light. By measuring the contrast in the same way as autofocus sensors in through-the-lens (TTL) single-reflex 35 mm cameras, the amount of diffusivity can be deduced. It is not necessary to claim about the sensor. Another way to identify the diffusiveness of the light is to measure the contrast ratio. In a colour LCD, photo detectors placed under the colour filters can provide the relative intensities of the primary colours and the illuminant can hence be estimated.

The sensor 11 is preferably located adjacent to the display unit.

The surface or other diffusion brought about as described herein is an intentional and controlled light scattering with the purpose of reduce potentially annoying specular reflection. The degree of annoyance is dependent on the kind of light source and is larger for point sources such as light bulbs. With too much scattering, the perceived brightness also decreases so there is a need to optimise the amount of scattering depending on the nature of the ambient light source. A point source like a light-bulb appears as a mirror image on a surface with little scattering whereas diffuse light from a cloudy sky appears less annoying.

The scattering itself occurs when light travels in a medium with regions of different refractive index. If the size of these regions are of the same order as the light wavelength and randomly distributed, random scattering, i.e. diffusion, will occur. In conventional fixed diffusers, this is accomplished by embedding small particles of a different refractive index. The amount of diffusion is determined by the size and density of these particles and the refractive index difference with respect to the surrounding medium. A fixed amount of diffusion can also be introduced by mechanically alter the surface so that it is no longer optically flat, i.e. introduce a random surface roughness which makes incoming light reflect in random directions. This is what happens on paper and in metal reflectors in reflective TFTLCDs.

Systems described herein propose to use polymer-dispersed liquid crystals (PDLC) as an adjustable diffuser. PDLC is a polymer into which droplets of liquid crystals are dispersed. The liquid crystal molecules are both optically and electrically anisotropic and have different refractive indices and dielectric constants along and perpendicular to the molecular axis. The dielectric constant along the molecular axis is larger than the constant perpendicular to the axis so if an electric field is applied, the molecules will orient themselves along the electrical field. It is therefore possible to align all the molecules in one direction by applying a voltage. Since the refractive index also is anisotropic, such an electrically induced reorientation will also change the refractive index seen by the incoming light. If this refractive index is matched to that of the surrounding polymer, there will not be any refractive index inhomogeneties and hence no scattering. On the other hand, with out the electric field applied, the LC droplets are randomly oriented and their average refractive index seen by the incoming light will be different from the surrounding polymer and scattering hence occurs. In this way, it is possible to electrically switch between a scattering and transparent state.

As an example of the properties that could be selected by the controller 9, FIG. 3 illustrates the reflection distributions for reflective surfaces suited for A: directed light, and B: diffuse light.

The adjustable diffuser is not limited to use with LCDs. It can be applied to any reflective or transflective display which comprises a specular (“mirrorish”) reflector. The best mirror effect is to be achieved in reflective displays with small absorption, i.e. displays which do not use polarisers (at least 50% absorption) or absorbing colour filters. The displays include, but are not limited to, guest-host LCDs with anisotropic dye guests, diffractive or interferometric micro electromechanical system (MEMS) displays, polymer-dispersed liquid crystal displays (PDLC).

Another use of the diffuser is to adapt the display to form a mirror. To do this the display could be made fully reflective. This has a number of potential uses and advantages. The mirror could be flat, convex, concave or of a complex shape.

1. If implemented in a portable device it could avoid the need for the user to carry both the device and a mirror. This implementation would be particularly well suited for personal devices such as clamshell-type mobile phones which are similar in shape to a conventional compact with a mirror.

2. It could enhance the aesthetic qualities of the device in which the display is implemented. The display could appear shiny until it was to be used, at which point the diffuser would be controlled to reduce reflectiveness so that the display could be viewed as normal. The visual effect would be especially striking if the display were implemented in a device the remainder of which had a reflective (e.g. chromed) surface.

The mirror could furthermore be colourized in order to compensate for chromatic ambient lighting in the environment to preserve an achromatic mirror image in most lighting conditions. Then, for example, a user in a green-coloured room could see a reflection of themselves as if they were in room with achromatic illumination.

Regions of the display could be individually controllable for adjustment of their reflectivity. This would make it possible to extend the functionality to overlay information on the mirror image. For example a user could check whether a proposed hairstyle suits their face by forming an image of the hairstyle in relatively reflective and non-reflective regions of the reflective portion of the display.

If the device that incorporated the mirror were to include image optics (e.g. a camera) the mirror could be used to set up photographs that the user was to take using the camera, for example a picture of the user himself. The camera does not need to be incorporated in the device. The mirror works as a viewfinder for taking pictures of oneself. The camera optics is designed in such a way that the mirror image is the same as what is being seen by the camera. By having the display working also as a mirror viewfinder, it is possible to overlay computer graphics on the mirror image and the user can see what he/she looks like with computer graphics added or overlaid. A conventional display can, of course, be used to display the image grabbed by the camera but this would mean reduced resolution and annoying delays. A mirror can provide a much higher resolution image than a pixellated display and so this solution would provide a more satisfactory image quality than could be obtained by using a display. Currently mirrors used for alignment are tiny (e.g. 4-7 mm) and heavily distorted by being convex. A mirror constituted by a display as described herein could be flat, and therefore have limited distortion and present a virtual image of the user in real size.

It should be noted that a PDLC diffuser layer can be expected to be less complex and more inexpensive to manufacture than diffusing metallic mirrors inside the display cell.

The approach described above can be employed to enhance the brightness of a display in situations where the ambient light is diffuse. This could reduces the need for auxiliary light sources. Without such light sources some displays could be made thinner, lighter, and more inexpensive. In addition the image distortion caused by scattering, absorption, and reflections in a front light can be overcome. Power consumption can also be in comparison to displays having auxiliary light sources.

The display device could preferably form the display of an electronic device, such as a mobile phone.

The present method of providing adjustable reflectivity in a reflector could be applied to controlling the diffusive (scattering) characteristics optical surfaces in situations other than displays.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. A display device comprising:
display element switchable to adjust the transmission of light therethrough; and
a reflector located behind the display element for receiving ambient light transmitted through the display element and reflecting it back through the display element;
wherein the diffusivity of the reflector is adjustable.

2. A display device as claimed in claim 1, wherein the reflector comprises a reflective layer and a layer having adjustable diffusivity located between the reflective layer and the display element.

3. A display device as claimed in claim 2, wherein the layer having adjustable diffusivity comprises polymer-dispersed liquid crystals.

4. A display device as claimed in claim 1, wherein the diffusivity of the reflector is electrically adjustable.

5. A display device as claimed in claim 1, wherein the display comprises a user-actuable input device and the diffusivity of the reflector is adjustable in response to the operation of the input device.

6. A display device as claimed in claim 1, wherein the display comprises a light sensor for sensing ambient light and generating an output signal in dependence thereon and the diffusivity of the reflector is adjustable in response to the output of the sensor.

7. A display device as claimed in claim 6, wherein the output of the light sensor is indicative of the diffusivity of the ambient light.

8. A display device as claimed in claim 7, comprising a display controller arranged to receive the output of the light sensor and adjust the diffusivity of the reflector in opposite dependence on the sensed diffusivity of the ambient light.

9. A display device as claimed in claim 6, wherein the sensor comprises two or more sensing units arranged in such a way that the diffusivity of the ambient light can be determined from their outputs.

10. A display device as claimed in claim 1, wherein the diffusivity of the reflector is adjustable to render the display fully reflective.

11. A display device as claimed in claim 10, wherein the display is located on the outer surface of an electronic device.

12. A display device as claimed in claim 11, wherein the electronic device is a portable device.

13. A display device as claimed in claim 11, wherein the outer surface of the electronic device is reflective in the region surrounding the display.

14. A display device as claimed in claim 13, wherein the display is a liquid crystal display.

15. A display device as claimed in claim 1, wherein the display is a MEMS display.

16. A reflector whose diffusivity is adjustable.
